(19) United States
(12) Patent Application Publication
(10) Pub. No.: US 2023/0371494 A1
(43) Pub. Date: Nov. 23, 2023

(54) INSECT STICKY TRAP WITH CORRUGATED SURFACE

(71) Applicant: Sterling International, Inc., Spokane, WA (US)

(72) Inventors: Qing-He Zhang, Greenacres, WA (US); Rodney G. Schneidmiller, Greenacres, WA (US); Marc Chapin, Spokane, WA (US)

(73) Assignee: Sterling International, Inc., Spokane, WA (US)

(21) Appl. No.: 18/358,813

(22) Filed: Jul. 25, 2023

Related U.S. Application Data
(63) Continuation-in-part of application No. 18/126,354, filed on Mar. 24, 2023.
(60) Provisional application No. 63/389,215, filed on Jul. 14, 2022.
(60) Provisional application No. 63/323,230, filed on Mar. 24, 2022.

(51) Int. Cl. A01M 23/00

(52) U.S. Cl. CPC A01M 23/005; A01M 2200/01

(57) ABSTRACT

An adhesive trap for entrapping pests such as insects such as flying or crawling insects, or other small creatures includes a corrugated panel defining a plurality of channels connected by convex peaks. For example, the corrugated panel, or a plurality of corrugated panels, may be configured and/or assembled to define a pillar or the like. An insect adhesive, such as pressure-sensitive adhesive, is adhered only in the plurality of channels, such that the convex peaks of the corrugated panel are free of adhesive. The adhesive trap is effective at capturing target insects, and the adhesive-free outer portions facilitate handling of the traps without contacting the adhesive and reduces the risk and likelihood of inadvertently ensnaring or adhesively engaging larger, non-target creatures.

### CROSS-REFERENCES TO RELATED APPLICATIONS

This application is a Continuation-In-Part of U.S. patent application Ser. No. 18/126,354, filed Mar. 24, 2023, which claims the benefit of U.S. Prov. Patent Appl. No. 63/323,230, filed Mar. 24, 2022, and claims the benefit of U.S. Prov. Pat. Appl. No. 63/389,215, filed Jul. 14, 2022. The entire disclosures of said applications are hereby incorporated by reference in their entireties.

### BACKGROUND

Insects of the order Diptera, sometimes referred to as “true flies,” including house flies, horse flies, stable flies, bottle flies, flesh flies, black flies, sand flies, and mosquitoes, are often significant disease vectors, nuisances, and pests. For example, the house fly, Musca domestica L. (Diptera: Muscidae), is one of the most important hygiene pests worldwide. True flies are not only a nuisance, irritating people and animals and leaving regurgitation and fecal spots on surfaces, but they are also vectors of pathogens that may cause serious diseases in humans and animals.

Similarly, insects of the order Hymenoptera, which include flying insects such as sawflies, social wasps, and bees, are also significant nuisances and pests. Social wasps, including paper wasps, hornets, and yellowjackets, are a significant hazard to people and animals engaged in outdoor activities due to their painful and potentially deadly stings. Such flying insects can be prevalent in rural settings and in very well-developed residential areas. Pestiferous insects from other orders, flying and otherwise, are also known, for example in agricultural and greenhouse settings and in other commercial venues, including, for example, meat packing factories, food processing facilities, and livestock ranches. Significant efforts are directed to combating the problems caused by pest insects, including the use of chemical control means such as pesticides, which may be annoying and/or harmful to persons or non-target animals. Many insects such as house flies and the like have developed resistance against commonly used insecticides due to typically high reproductive rates. Moreover, insecticides that are effective against pestiferous insects may not be an attractive option to persons having concerns regarding personal health effects, environmental effects, and the like.

As a part of environmentally sound pest control strategies, insect traps baited with benign semiochemicals and/or with visual attractants (for flying or walking insects) have been quite successful at attracting and trapping target insects and are known in the art. See, for example, U.S. Pat. No. 9,015,988 to Zhang et al., which is hereby incorporated by reference.

Insect traps that use an adhesive to capture flying insects, for example fly paper, fly strips, and fly ribbons, are well-known in the art, and are sometimes referred to conventionally as “sticky traps”. Insect traps that use an adhesive to entrap insects have obvious safety and environmental advantages, for example they do not require the use or widespread application of toxic chemicals. For example, certain adhesive traps commonly referred to as “yellow sticky cards” (also called “yellow sticky traps”), are well known adhesive traps for combatting damaging insects, and are typically an important part of an Integrated Pest Management (IPM) program in agricultural settings. Yellow sticky cards are widely used for monitoring and/or mass-trapping target pest insects such as fruit flies, fungus gnats, whiteflies, aphids, leaf miners, thrips, psyllids, leafhoppers, buprestid beetles, etc., in both greenhouses and field crops. A cylindrical pillar device that is suitable for use as a sticky trap is disclosed in U.S. Pat. No. D700,269 to Chapin et al., issued on Feb. 25, 2014. Such adhesive traps are suitable for catching various flying insects including, for example, pestiferous social wasps, carpenter bees, biting flies, and nuisance flies.

Typically, sticky traps are coated with adhesive covering all or a portion of a planar or curved surface of the trap. The adhesive is exposed for entrapping insects that crawl, walk, alight or otherwise engage the adhesive surface. Although adhesive strips, sticky cards or pillar/stick traps have found success, a risk associated with traps that rely on an exposed adhesive to entrap flying insects is that nontarget species, including for example, birds, bats or other small animals, may inadvertently become ensnared by the adhesive, which can result in injury to the nontarget species and/or destruction of the trap. The exposed sticky surfaces may also create an annoyance to users, for example by transferring adhesive onto a user's hands/fingers or gloves when handling the traps, or adhering to clothing, tools, or other implements.

Prior art solutions for reducing the entanglement of nontarget species with adhesive traps have had some success, for example pillar/stick traps available under the RESCUE! and TRAPSTIK registered trademarks for flies, wasps, and carpenter bees may be provided with fence-type guards. See, for example, U.S. Pat. No. D831,782, issued on Oct. 23, 20218; U.S. Pat. No. D846,059, issued on Apr. 16, 2019; U.S. Pat. No. D873,949, issued on Jan. 28, 2020; U.S. Pat. No. D915,544, issued on Apr. 6, 2021; and U.S. Pat. No. 10,980,224, issued on Apr. 20, 2021, which are hereby incorporated by reference. Adhesive traps with bird guards have had significant success in reducing the inadvertent entanglement of birds and bats; however, in addition to the added costs, bird guards may also reduce the numbers of target insects captured by the trap due to the physical blockage of visual attractors on the traps, and/or the particular landing activity of the target insects.

There remains a need for insect sticky traps that minimize or eliminate the bird/bat by-catch, improves the user experience in setting up the trap, and keep high trapping efficacy of the target insects. An adhesive insect trap that prevents or reduces the entrapment of nontarget species, and that allows the user to handle the trap without accidental contact with the adhesive feature of the trap, without requiring blocking guards or the like, is disclosed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

An adhesive trap is disclosed that includes a corrugated panel defining a plurality of channels connected by convex peaks, the peaks having a width. A pressure sensitive adhesive is applied only to the plurality of channels, and the convex peaks of the corrugated panel are free of any adhesive.

In an embodiment the pressure-sensitive adhesive comprises a bead of adhesive, and in some embodiment the bead of adhesive defines an outward-facing planar surface.

In an embodiment the pressure-sensitive adhesive comprises a thin adhesive layer.

In an embodiment a linerboard is fixed along a face of the corrugated panel.

In an embodiment the plurality of channels have a height that is between 1/32 inches and 1 inch inclusive.

In an embodiment the corrugated panel comprises between 50 corrugations per meter and 500 corrugations per meter.

In an embodiment the corrugated panel is flat or curved.

In an embodiment the corrugated panel comprises a tubular pillar, for example the tubular pillar may have a circular, hexagonal, triangular, or rectangular cross section.

In an embodiment the plurality of channels are parallel channels.

### DESCRIPTION OF THE DRAWINGS

The patent or application file contains at least one drawing executed in color. Copies of this patent or patent application publication with color drawing(s) will be provided by the Office upon request and payment of the necessary fee.

The foregoing aspects and many of the attendant advantages of the disclosed subject matter will become more readily appreciated as the same become better understood by reference to the following detailed description, when taken in conjunction with the accompanying drawings, wherein:

FIG. 1 illustrates corrugation pitch and height, sometimes referred to as thickness, parameters for a conventional corrugated panel, wherein the corrugated panel is shown with a linerboard;

FIGS. 2A, 2B, and 2C illustrate a portion of an adhesive insect trap in accordance with three separate embodiments of the present disclosure, wherein a uniform thickness of an adhesive is provided only in valley or channel portions of the corrugations, and a protruding portion of each corrugation does not have any adhesive;

FIGS. 3A, 3B, and 3C illustrate a portion of an adhesive insect trap in accordance with three separate embodiments of the present disclosure, wherein an adhesive layer of non-uniform thickness is provided only in channels, sometimes referred to as valleys, of the corrugations, and a protruding portion of each corrugation does not have any adhesive;

FIG. 4A is a top perspective view of a portion of an adhesive trap as shown in FIG. 3C, with an insect captured by the adhesive trap;

FIG. 4B is a top perspective view of a portion of an insect captured by the adhesive insect trap shown in FIG. 3A;

FIG. 5A shows an adhesive trap in accordance with an embodiment of the present disclosure, formed as a flat panel;

FIG. 5B shows an adhesive trap in accordance with an embodiment of the present disclosure, formed or assembled as an upright circular cylinder;

FIG. 5C shows an adhesive trap in accordance with an embodiment of the present disclosure, formed or assembled as an upright hexagonal cylinder;

FIG. 5D shows an adhesive trap in accordance with an embodiment of the present disclosure, formed or assembled as an upright triangular cylinder;

FIG. 5E shows an adhesive trap in accordance with an embodiment of the present disclosure, formed or assembled as an upright square cylinder;

FIG. 6A shows a perspective view of an adhesive trap in accordance with an embodiment of the present disclosure, the adhesive trap providing a visual attractant for target insects;

FIG. 6B shows a top view of the adhesive trap shown in FIG. 6A;

FIG. 7A shows the results of a first experiment demonstrating the efficacy of an adhesive trap formed in accordance with an embodiment of the present disclosure; and

FIG. 7B shows the results of a second experiment demonstrating the efficacy of an adhesive trap formed in accordance with an embodiment of the present disclosure;

### DETAILED DESCRIPTION

Examples of an adhesive trap configuration are disclosed, which provides one or more corrugated surfaces or panels, wherein the adhesive panels are easier to handle and are less likely to entrap larger, non-target animals or to be damaged by inadvertent interaction with larger animals or the like. As used herein a corrugated panel (or corrugated sheet) is defined conventionally as a panel “shaped into wavy folds or alternating furrows and ridges” (see www.dictionary.com). The adhesive trap construction disclosed herein may be applied to a variety of pests, for example arthropods (e.g., insects), arachnids (e.g., spiders), reptiles, amphibians, small mammals (e.g., rats, mice, etc.), and the like, providing a new tool for combatting pestiferous and/or disease-vector critters.

Different corrugated panels or surface structures are contemplated. For example, a common corrugated material on the market is a single face corrugated fiberboard (for example, “corrugated paper-based cardboard”), having a fluted corrugated surface on one side of the sheet and a flat linerboard on an opposite side of the sheet. The flat bottom linerboard can be replaced with a single, double, or triple wall board to increase the strength of the overall cardboard structure. In some embodiments, the corrugated surface may also be made of relatively sturdy materials, such as fiberglass, plastic, or glass, and may omit the linerboard. These materials can have any level of opacity, can be translucent, and/or can be clear. In some embodiments, materials can have color or be colorless.

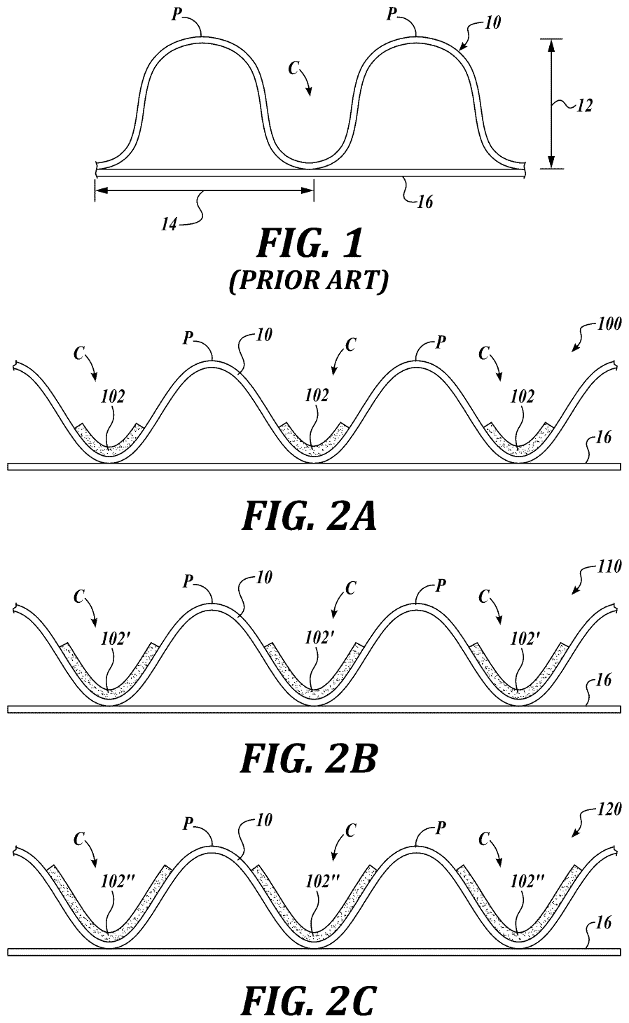

FIG. 1 is a schematic view illustrating a conventional corrugated panel 10 defining a plurality of alternating ridges or peaks P (two shown) and grooves or channels C between adjacent peaks P. The channels C have a height 12 and a period or width 14. The corrugated panel 10 is shown optionally fixed to a linerboard 16, for example with an adhesive, fasteners, or the like. The linerboard 16 improves the structural rigidity of the corrugated panel 10.

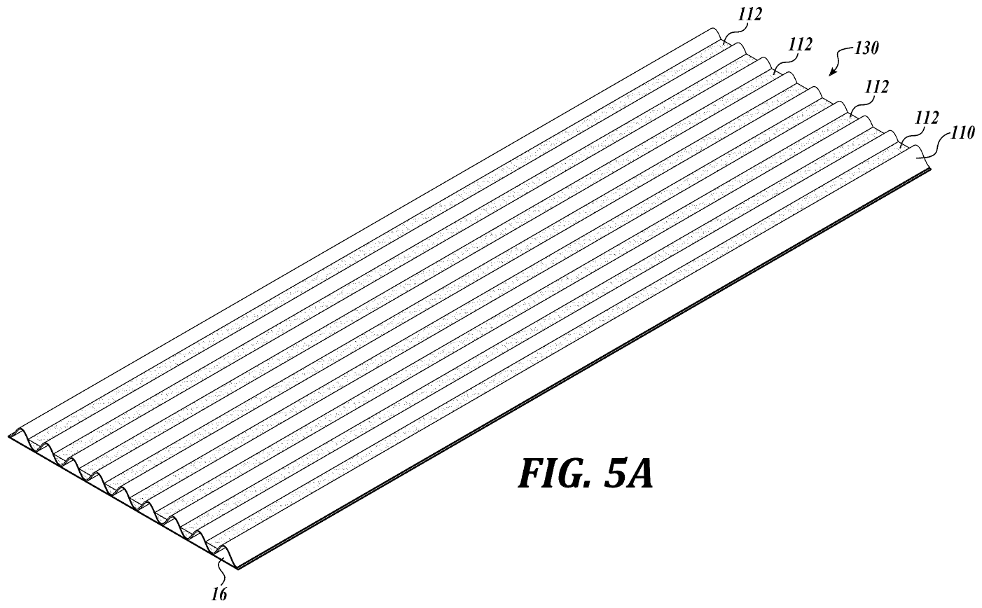

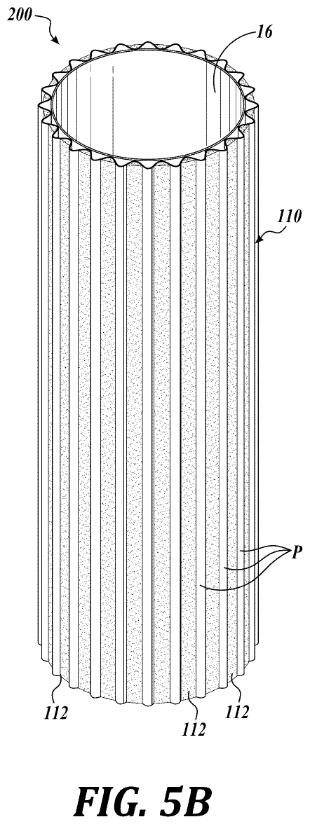

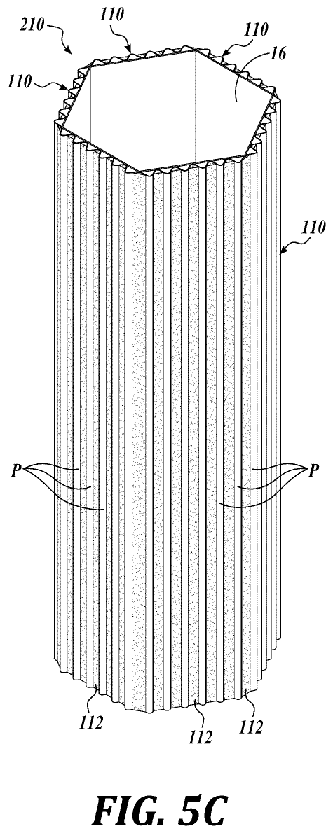

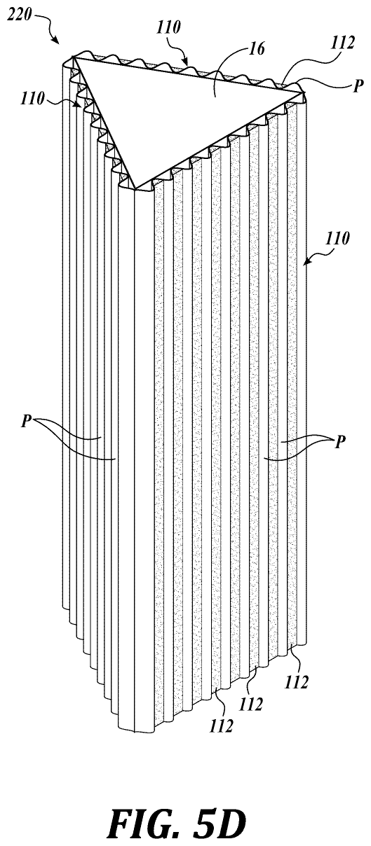

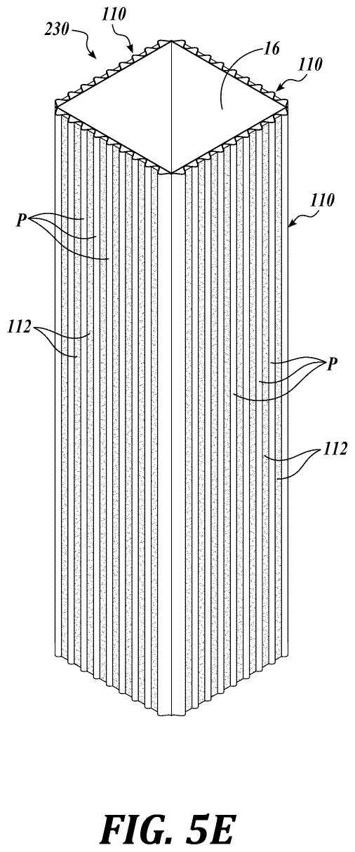

FIGS. 2A, 2B, and 2C are end views of three adhesive corrugated panel assemblies 100, 110, 120 respectively for an adhesive trap in accordance with the present disclosure. Examples of adhesive traps that may be constructed using any of these corrugated panels are shown in FIGS. 5A-5E. Each of the corrugated panel assemblies 100, 110, 120 include a corrugated panel 10 and an optional linerboard 16 fixed to the corrugated panel 10. The corrugated panel 10 is preferably made from relatively sturdy materials, for example fiberglass, plastic, or glass. In currently preferred embodiments the corrugation height 12 of the corrugated panel 10 is between 1/32 inches and ½ inches.

In FIG. 2A each of the channels C in the corrugated panel 10 has a strip of insect adhesive 102, e.g., a pressure-sensitive adhesive material 102 (“adhesive material 102”), that is provided as a thin adhesive layer disposed generally along a center portion of the channel C. The adhesive material 102 preferably extends along most or all of the length of the associated channel C. The adhesive material 102 is applied or affixed to the channel C such that the adhesive material 102 extends to approximately one third the height 12 of the channel C, for example between 30% and 40% of the channel height 12. The adhesive material 102 may be applied to the channel C in any suitable manner. For example, the adhesive material 102 may be sprayed onto the associated channel C, applied with a brush or roller, or adhered directly to the panel 10 as a double-sided sticky tape. FIG. 2B illustrates a corrugated panel assembly 110 similar to the assembly 100 shown in FIG. 2A, including an adhesive material 102′ disposed generally along a centerline of the associated channel C, defining a thin adhesive layer. The adhesive material 102′ is approximately centered in the associated channel and in this embodiment extends laterally to approximately half the height 12 of the channel, for example between 45% and 55% of the channel height 12.

FIG. 2C illustrates a corrugated panel assembly 120 similar to the assembly 100 shown in FIG. 2A, including an adhesive material 102″ disposed generally along a centerline of the associated channel C in a thin adhesive layer. The adhesive material 102″ is approximately centered in the associated channel and in this embodiment extends laterally to approximately three quarters the height 12 of the channel C, for example between 70% and 80% of the channel height 12.

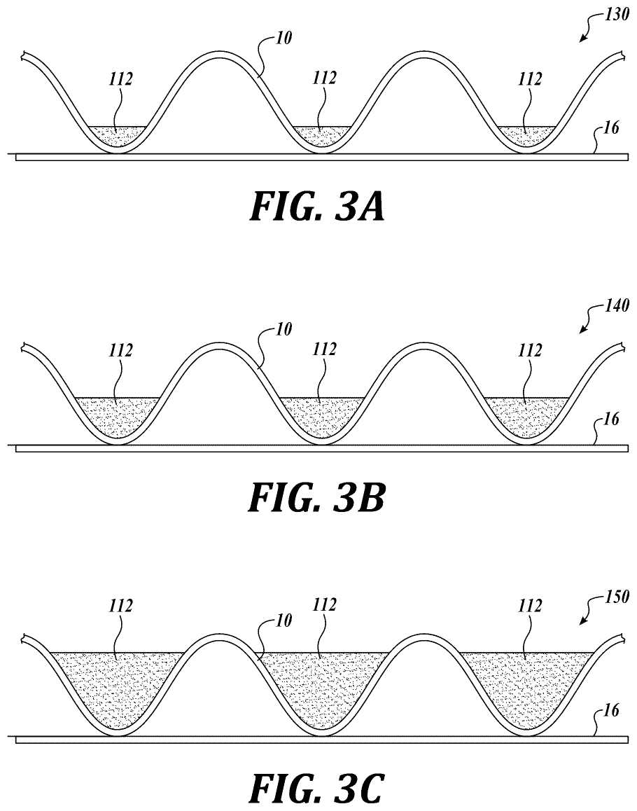

FIGS. 3A, 3B, and 3C show end views of three other embodiments of corrugated panel assemblies 130, 140, 150 respectively for an adhesive trap in accordance with the present disclosure, and except as discussed below are similar to the embodiments described above. In these embodiments, the adhesive material 112 is disposed generally along a centerline of the associated channel C and is applied such that the adhesive material 112 is a bead of adhesive that partially fills the associate channel C, defining a generally planar, outwardly-facing adhesive surface in the associated channel C, and between peak portions of the corrugated panel.

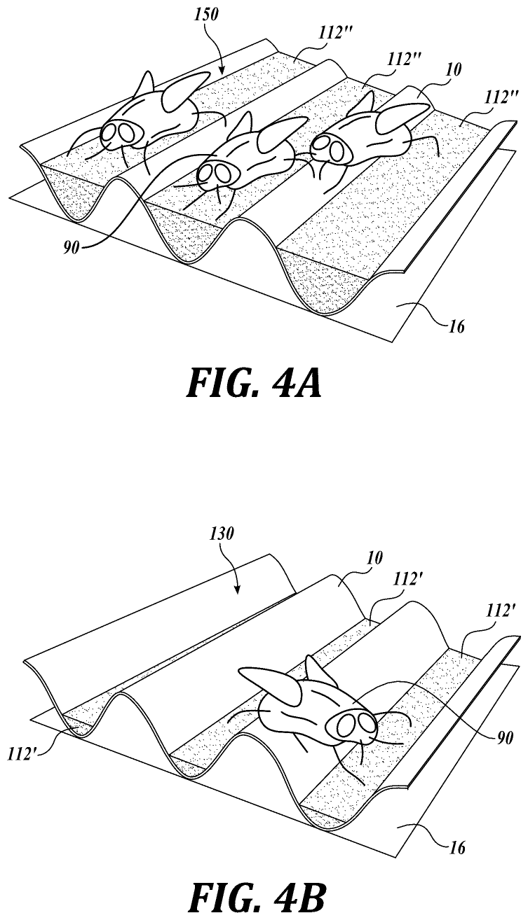

In FIG. 3A, the adhesive material 112 fills the associated channel to approximately one third the height 12 of the channel, for example between 30% and 40% of the channel height 12, and presents a generally flat, outwardly-facing adhesive face. In FIG. 3B, the adhesive material fills the associated channel to approximately half the height 12 of the channel C, for example between 45% and 55% the height of the channel, and defines a generally flat, outwardly-facing adhesive face. In FIG. 3C, the adhesive material fills the associated channel to approximately three-quarters the height 12 of the channel, for example between 70% and 80% of the channel height 12. FIG. 4A is a perspective view of a portion of the corrugated panel assembly 150, and illustrating a pest 90 entrapped by the adhesive 112″. A target pest engaging the adhesive material 112″ similar to prior art adhesive pest devices such as fly paper and the like. Similarly, FIG. 4B illustrates a pest 90 entrapped by the adhesive 112′ of panel assembly 130. It will be appreciated that the a larger (non-target creature), for example, may engage the corrugated panel assemblies without becoming ensnared by the adhesive material recessed in the channels of the panel assemblies described above. Moreover, a person deploying, moving, or otherwise engaging with the adhesive panels may avoid direct contact with the adhesive material.

The size and shape of the channels C in the corrugated panels, and type and quantity of adhesive provided in the channels C may be optimized for a particular application. For example, the pest 90 is shown in FIGS. 4A and 4B entrapped in various orientations, e.g., partially or fully longitudinally between corrugations (FIG. 4A), longitudinally straddling corrugation peaks (FIG. 4A), perpendicularly straddling corrugation peaks (FIG. 4B), etc. It should be appreciated that other entrapment orientations are also within the scope of the present disclosure. In some embodiments, it is intended that the corrugation size and shape permits the target pest to engage the adhesive material with at least two legs (e.g., the front leg set, the center leg set, the rear leg set, the right set of legs, the left set of legs, the front and rear legs, etc., or combinations thereof), to become more securely entrapped. Further, because the adhesive is provided only within the channels C, the outer perimeter of the corrugated flutes (i.e., ridges and grooves, see FIGS. 2-3) can be varied or adjusted for particular applications, for example depending on the size of the target insects and/or to avoid ensnaring non-target animals, such as birds, (with consideration of feather structures, perching behavior, and feet), bats, small rodents, and the like.

Optimal sizes and shapes of the corrugated flutes may also take into consideration typical human finger sizes to minimize user entanglement, as well as glue application requirements, coating area, etc. Common sizes of single-face corrugated flutes (paper cardboards) are A, B, C, E, and F flutes, the characteristics of which are set forth in Table 1 below. Flute thickness (height), wavelength (pitch) as well as paper (or plastic) thickness for flutes and flat linerboard are variables that can be adjusted to be optimized for different target insects and/or applications. For sturdy plastic, glass or fiberglass corrugated surfaces, no linerboard is needed. For example, a corrugated panel may be stood upright or hung with the adhesive applied in furrows on both sides of the panel; thus, the flute types and sizes for the single-face paper cardboards are contemplated for the more rigid materials without linerboard.

TABLE 1
Standard US corrugated flute sizes

| | Flutes | Flute | Flutes | Flute |
|---|---|---|---|---|
| Flute | per | thickness | per | thickness |
| designation | foot | (inch) | meter | (mm) |
| A flute | 33 ± 3 | ⅜ | 108 ± 10 | 4.8 |
| B flute | 47 ± 3 | ⅛ | 154 ± 10 | 3.2 |
| C flute | 39 ± 3 | 5/32 | 128 ± 10 | 4 |
| E flute | 90 ± 4 | 1/16 | 295 ± 13 | 1.6 |
| F flute | 125 ± 4 | 1/32 | 420 ± 13 | 0.8 |

In some embodiments, the corrugated panel is flexible, and is configured to wrap around a fixed object, for example a tree trunk, or a movable object such as a movable container or post. For example, the corrugated panel may be formed as a flexible elongated panel, which is configured to be installed as a spiraled wrap around the movable or fixed object. It is contemplated, for example, that a corrugated panel may include adhesive in the channels of one or both sides of the panel and is wrapped around the base of the object. In some embodiments it may be preferable to install corrugated adhesive panels in alternating arrangements with adhesive applied on opposite sides of adjacent panels. The particular pattern of the adhesive placement may be configured to the specific behavioral characteristics of the pest targeted by the particular application.

In representative embodiments, the adhesive may be any pressure sensitive adhesive (“PSA”), or other type of glues that will adhesively ensnare a target insect. It is contemplated that the adhesive may be applied using (i) one or more spray heads (air spray or airless spray), (ii) wheel/roller systems, (iii) jetting systems, (iv) slot applicators/extruders, and/or (v) brush and/or trowel systems, for example. Other adhesive application systems as are known in the art may alternatively be used, including applying or printing narrow strips of adhesives or adhesive tapes into the furrows. In another embodiment an adhesive is applied to the entire surface and non-adhesive blocking strips are applied over the peaks of the corrugations that block the adhesive from adhering to the peaks.

In one method of making the adhesive trap with the desired glue area/thickness and patterns, glue is applied to the furrows in strips as a thin layer of adhesive membrane, e.g., thickness range from 1-60 mil, to cover a bottom ¼ to ½ or ¾ of the valley-ridge sloped surface area, in the grooves, leaving the corrugation top section (upper ridge section) with no adhesive. For example, the non-adhesive portions may comprise ¼ or more total corrugation area. In some embodiments, an adhesive may be applied as a thick bead having a diameter, for example, ⅓ to ½ or less of the groove height. Although uniform spacing of the corrugated surfaces are shown, it is contemplated that the corrugation spacing may be non-uniform. In some embodiments the ridge sections may be non-parallel, for example expanding in a fan-like arrangement.

Regardless of the corrugation types (sizes), the glue area along with the thickness of the glue in the groove should be sufficient to ensnare or capture target pests but restricted to the channels of the corrugated sheet or panel such that the corrugated panel may be handled by a user without contacting the adhesive directly, and to avoid or reduce the risk of contact by feathers or body parts of non-target creatures such as birds or bats. For example, the selected corrugation sizes or combination of corrugation sizes, and the glue area/thickness may be selected to engage multiple insect legs (at least 2) of a target insect no matter where the target insect lands on the corrugated surface.

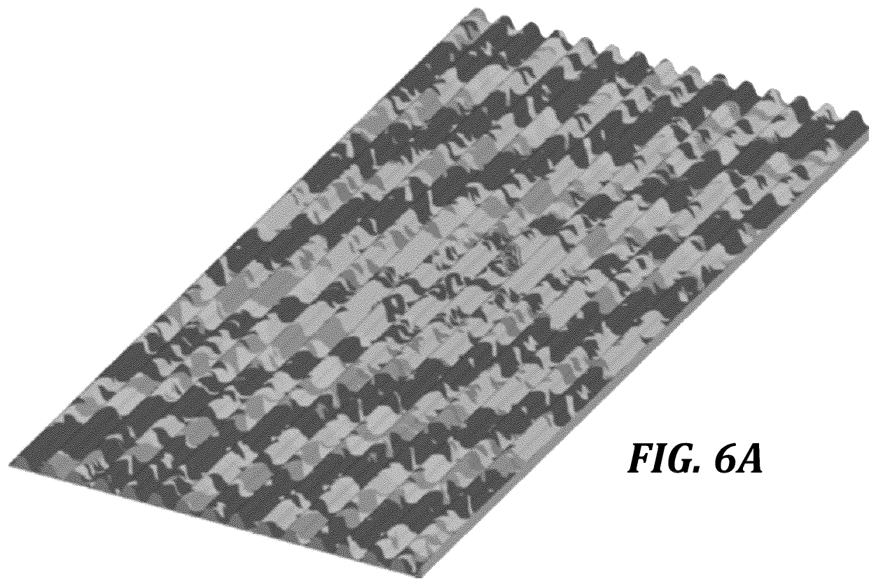

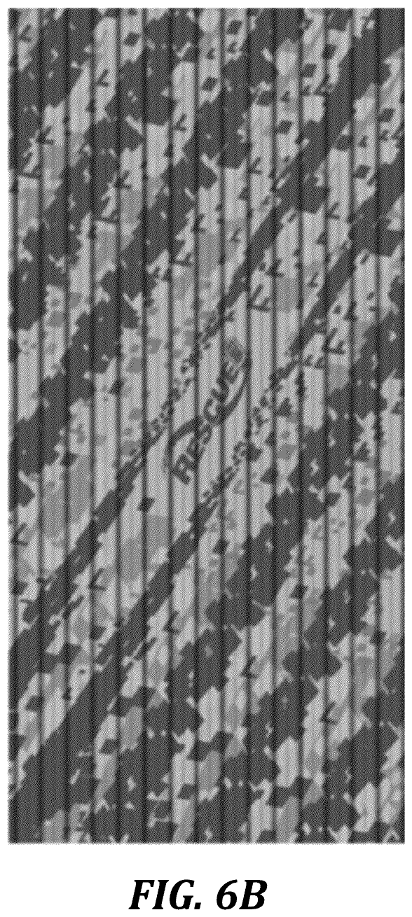

It is contemplated that the corrugated or fluted panels may have color and/or pattern combinations providing a visual attractant for target insects, such as flies and/or social wasps. Examples of visual attractants on flat surfaces are disclosed in U.S. Pat. No. 9,015,988, to Zhang et al., which is hereby incorporated by reference in its entirety. It is believed that the three-dimensional characteristics of visual attractants on a corrugated surface will likely improve the efficacy of the attractant to target insects. One certain embodiment of the adhesive trap providing a visual attractant for target insects is shown in FIGS. 6A and 6B.

FIG. 5A illustrates a panel structure 110 that may be formed using any of the embodiments shown in FIG. 2A-2C or 3A-3C. In some embodiments, the corrugated panel 100 has corrugations having a height between 1/32 inches and 1 inch, inclusive, and the corrugations are spaced to provide between 50 corrugations per meter and 500 corrugations per meter. In other embodiments, the corrugated panel 100 has corrugations having a height between 1/32 inches and ½ inches, inclusive, and the corrugations are spaced to provide between 98 corrugations per meter and 433 corrugations per meter.

A plurality of the panels 110 may be assembled or manufactured unitarily such as a hexagonal pillar 210 shown in FIG. 5C, a rectangular pillar 220 shown in FIG. 5D, a square pillar 230 shown in FIG. 5E. Non-corrugated pillar devices for insect visual attractant are disclosed, for example, U.S. Des. Pat. No. D700,269, to Chapin et al., which is hereby incorporated by reference in its entirety. It will be appreciated by persons of skill in the art that the target insects for adhesive insect traps may inform the placement of the adhesive.

In some embodiments, the corrugated panel may be formed as an elongated flexible ribbon or tape that may be wrapped in a spiraling arrangement around an existing structure, for example a tree, fencepost, light post, power pole, or the like. For example, it is contemplated that spacers (not shown) may be fixed to an inner surface of the elongated flexible ribbon or tape, such that the flexible ribbon is spaced away from the structure, to provide insect (or other pest) access to space between the structure and the ribbon. An adhesive applied only to the side of the flexible ribbon facing the structure would provide a non-adhesive outer face, and an inner surface that does not adhere to structure.

### EXAMPLES

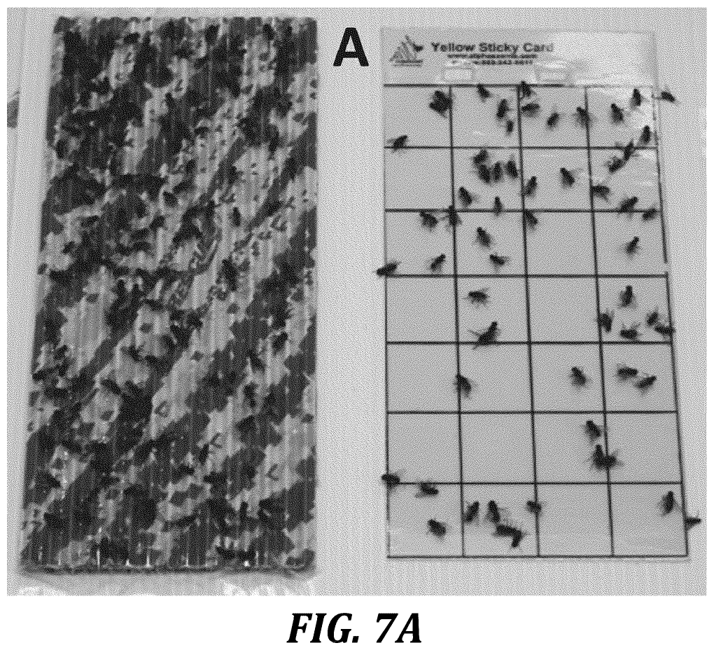

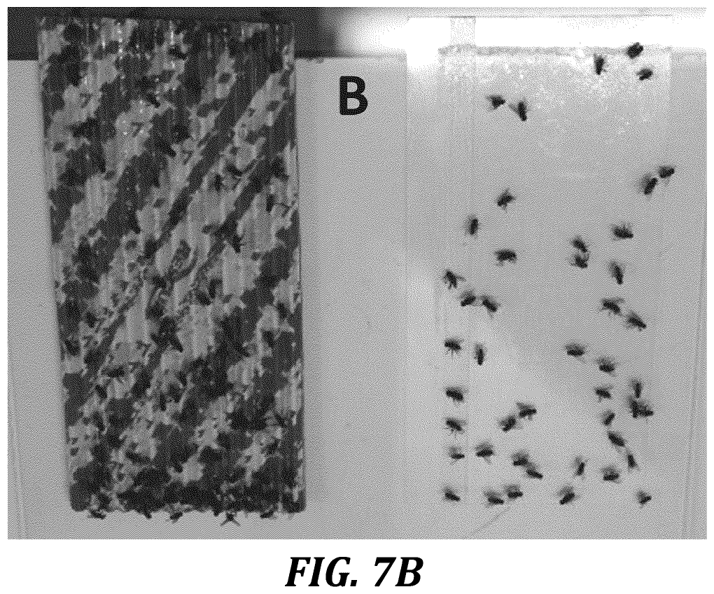

Two trapping efficacy experiments were carried out in a laboratory wind-tunnel to compare the adhesive trap of the present disclosure shown in FIG. 6A-6B against two commercial flat sticky traps: Yellow Sticky Card Trap and Clear Window Sticky Trap (Alpha Scents, Inc.; See FIGS. 7A and 7B) on house flies, Musca domestica.

Materials & Methods

Insects

The house flies were received as pupae from Beneficial Insectary in Redding, California. The flies were reared to adults on a 14:10 hour light to dark schedule at about 20-24° C. with roughly 10-15% Relative Humidity.

Traps

An adhesive trap formed with a flat corrugated cardboard panel (9.7 cm×20 cm) Attractive colors (blue/green), patterns, and contrasts were printed on the corrugated surface to form a visual attractant. An adhesive coating was applied only in the flute valleys of the corrugated panel. An example of the adhesive trap that was used in these experiments is shown in FIGS. 6A-6B.

The two Alpha Scents Inc. Sticky Traps (see FIGS. 7A-7B) were then prepared by fully coating both with adhesive on the sticky side covered by a release liner. These Sticky Traps were cut to the same dimensions to make the overall trap size (glued area) consistent and comparable for testing.

Testing Chamber: Wind-Tunnel

Both experiments (Experiments 1 and 2) were tested in a laboratory wind-tunnel without the airflow running. The wind-tunnel is constructed of clear acrylic panels with metal frame material and is about 200 cm×82.5 cm×82.5 cm in size.

Testing Procedures

Experiment 1 tested an adhesive trap vs. Yellow Sticky Card Trap (Alpha Scents, Inc.). These two sticky traps were attached centered to a white corrugated plastic board (25 cm×33 cm) side by side about 2 cm apart. Experiment 2 tested the corrugated panel vs. Clear Window Sticky Trap (Alpha Scents, Inc.). These two sticky traps were attached centered to a glass pane (27.5 cm×35 cm) side by side about 2 cm apart. For each test, the trap holding board (plastic or glass) was hung 13.5 cm from the ceiling on one side of the wind-tunnel at 30 cm away from the end while 1-2 jars of (approximately 400) house flies were released from the other side into the wind-tunnel at 25.5 cm from the end for the first 10 minutes of testing. The fly jar was removed from the wind-tunnel after 10 minutes.

Observations were made for the first 15 minutes of testing to see how the flies react to the sticky substrates, and the testing was continued for a total of 2 hours. After 2 hours, the white corrugated board or the glass pane was removed from the wind-tunnel to count how many house flies were caught on each trap. The remaining flies were vacuumed out of the wind-tunnel after each run. For the next round of testing, the positions of the treatments were switched so that if the adhesive trap was on the right side it would be on the left side, and the Alpha Scents, Inc. trap would go from the left side to right side. This would eliminate or reduce any positional bias that might appear during the testing. This next test run was completed in the same way as described above in the procedure. The numbers of flies caught from these two test runs were recorded and pooled together by treatment as a full replicate for the data analysis using the Paired t-Test with SPSS 29.0 for Microsoft Windows. For each experiment, 6 full replicates were completed.

Results

In Experiment 1, a total of 1535 house flies were captured in 6 full replicates of testing in the wind-tunnel. The adhesive traps caught on average 180.17 flies per full replicate, which was approximately 2.38 times (significantly) higher than did the Alpha Scents, Inc. Yellow Sticky Card Traps (see FIG. 8A; Paired t-test: t=8.29; df=5; p<0.0005). For the full results of Experiment 1, please see Table 2 below.

TABLE 2
Numbers of house flies captured on Adhesive Trap (e.g., FIG. 6A)
vs. Alpha Scents, Inc. Yellow Sticky Card Traps in wind-tunnel (n = 6)

| Testing | Replicate | Total # of house flies captured per replicate | |
|---|---|---|---|
| Date | # | Adhesive Trap | Yellow Sticky Card Trap |
| Feb. 21, 2023 | 1 | 169 | 86 |
| Feb. 22, 2023 | 2 | 159 | 80 |
| Feb. 22, 2023 | 3 | 146 | 66 |
| Feb. 28, 2023 | 4 | 184 | 74 |
| Feb. 28, 2023 | 5 | 207 | 90 |
| Mar. 1, 2023 | 6 | 216 | 58 |
| Mean | | 180.17 | 75.67 |
| SE | | 11.19 | 4.96 |

In Experiment 2, a total of 1714 house flies were captured in 6 full replicates of testing in the wind-tunnel. The adhesive traps caught on average 208.5 flies per full replicate, which was approximately 2.70 times (significantly) higher than did the Alpha Scents, Inc. Clear Window Sticky Trap (FIG. 8B; Paired t-test: t=25.44; df=5; p<0.0001). For the full results of Experiment 2, please see Table 3 below.

TABLE 3
Numbers of house flies captured on Adhesive Trap (e.g., FIG. 6A)
vs. Alpha Scents, Inc. Clear Window Sticky Traps in wind-tunnel (n = 6)

| | Replicate | Total # of house flies captured per replicate | |
|---|---|---|---|
| Test Date | # | Adhesive Trap | Clear Window Sticky Trap |
| Feb. 23, 2023 | 1 | 180 | 58 |
| Feb. 23, 2023 | 2 | 208 | 75 |
| Feb. 24, 2023 | 3 | 211 | 67 |
| Mar. 1, 2023 | 4 | 188 | 77 |
| Mar. 2, 2023 | 5 | 235 | 93 |
| Mar. 2, 2023 | 6 | 229 | 93 |
| Mean | | 208.50 | 77.17 |
| SE | | 11.19 | 4.96 |

In both experiments, the special color combination, pattern, and contrast on the adhesive traps seemed to be strongly attractive to house flies compared to the clear or solid yellow color from the Alpha Scents, Inc. traps. Almost all the house flies that landed on the adhesive traps were caught even though only the valleys of the corrugated surface were coated with adhesive. As observed, an adhesive trap according to one or more aspects of the present disclosure and including a suitable combination of flute size, glue area/thickness, and size of target insect species would ensure multiple insect legs (at least 2) of a target insect to touch and be ensnared by the adhesive no matter where the target insect lands on the corrugated surface.

The detailed description set forth above in connection with the appended drawings are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

It should be noted that for purposes of this disclosure, terminology such as “upper,” “lower,” “vertical,” “horizontal,” “fore,” “aft,” “inner,” “outer,” “front,” “rear,” “top”, “bottom,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this document, the same or similar elements may bear the same references. Furthermore, the presence of reference numbers or letters in the drawings cannot be considered limiting, even when such numbers or letters are indicated in the claims.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

The embodiments of the invention in which an exclusive property or privilege is claimed are defined as follows:

1. An adhesive trap for trapping insect or arthropod pests, the adhesive trap comprising:
a corrugated panel defining a plurality of channels connected by convex peaks having a width; and
an insect adhesive adhered only to the plurality of channels, wherein the convex peaks of the corrugated panel are free of any insect adhesive.

2. The adhesive trap of claim 1, wherein the insect adhesive comprises a bead of pressure-sensitive adhesive.

3. The adhesive trap of claim 2, wherein the bead of pressure-sensitive adhesive defines an outward-facing planar surface.

4. The adhesive trap of claim 1, wherein the insect adhesive comprises a thin adhesive layer.

5. The adhesive trap of claim 1, further comprising a linerboard that is fixed along a face of the corrugated panel.

6. The adhesive trap of claim 1, wherein the plurality of channels have a height that is between 1/32 inches and 1 inch, inclusive.

7. The adhesive trap of claim 1, wherein the corrugated panel comprises between 50 corrugations per meter and 500 corrugations per meter.

8. The adhesive trap of claim 1, wherein the corrugated panel comprises a tubular pillar.

9. The adhesive trap of claim 8, wherein the tubular pillar has a circular, hexagonal, triangular, or rectangular cross section.

10. The adhesive trap of claim 1, wherein the plurality of channels are parallel channels.

11. The adhesive trap of claim 1, wherein the corrugated panel is a tubular member.

12. The adhesive trap of claim 11, wherein the tubular member has a round, square, triangular, or hexagonal cross section.

13. The adhesive trap of claim 1, wherein the corrugated panel is flat or curved.

14. The adhesive trap of claim 1, wherein the corrugated panel is flexible so as to be capable of being wrapped around an existing structure.

15. An adhesive insect trap comprising:
at least one corrugated panel defining a plurality of channels that are connected by convex peaks such that the channels are spaced apart;
an insect adhesive disposed on at least a center portion of each of the channels;
wherein the convex peaks do not have any insect adhesive.

16. The adhesive insect trap of claim 15, wherein the at least one corrugated panel comprises a tube that is circular, triangular hexagonal, or square in cross section.
